(19) United States
(12) Patent Application Publication
(10) Pub. No.: US 2007/0168227 A1
(43) Pub. Date: Jul. 19, 2007

(54) System and Method for Automated Screening of Individuals for Various Weight Loss Treatment Options

(76) Inventors: Joseph E. Fleming, North Oaks, MN (US); Melanie Middleton, Memphis, TN (US); Roland C. Maude-Griffin, Edina, MN (US)

Correspondence Address: MEDTRONIC, INC., 710 MEDTRONIC PARKWAY NE, MINNEAPOLIS, MN, 55432-9924, US

(21) Appl. No.: 11/620,657

(22) Filed: Jan. 6, 2007

Related U.S. Application Data
(60) Provisional application No. 60/757,072, filed on Jan. 6, 2006.

(51) Int. Cl. G06Q 50/00

(52) U.S. Cl. 705/2

(57) ABSTRACT

A system and method for performing an internet-based automated assessment of an individual as a candidate for various weight loss therapies is described. The system and method includes providing a web site where a candidate can access and answer a questionnaire. The password for accessing the website is provided by a health care provider to whom the candidate has consulted regarding weight loss therapies. The information received from the candidate is sent to a database network site where the information is analyzed to predict a weight loss outcome or expected outcome for the candidate for a weight loss therapy. Information regarding the candidate's physical and medical health sent by the candidate's health care provider to the database network site may be combined with the information provided by the candidate in the assessment of a candidate.

### RELATED APPLICATION

This application claims the benefit of provisional U.S. Application Ser. No. 60/757,072, filed Jan. 6, 2006, the entire contents of which are herein incorporated by reference.

### FIELD OF THE INVENTION

The present invention relates to a method and system for screening an individual as a candidate for various treatment options for weight loss. In particular, the disclosed method and system uses Internet-based communication for simplified acquisition of information from the individual and/or his or her health care provider.

### BACKGROUND OF THE INVENTION

Obesity is a major health concern in the United States and other countries. A significant portion of the population is overweight with the number increasing every year. Obesity is one of the leading causes of preventable death. Obesity is associated with several co-morbidities that affect almost every body system. Some of these co-morbidities include: hypertension, heart disease, stroke, high cholesterol, diabetes, coronary disease, breathing disorders, sleep apnea, cancer, gallstones, and musculoskeletal problems. An obese patient is also at increased risk of developing Type II diabetes.

Multiple factors contribute to obesity, including physical inactivity and overeating. A variety of medical approaches have been devised for treatment of obesity. Existing therapies include diet, exercise, appetite suppressive drugs, metabolism enhancing drugs, surgical restriction of the gastric tract, and surgical modification of the gastric tract. In general, surgery is reserved for patients in whom conservative measures, such as monitoring caloric intake or controlling appetite with appetite suppressants, have failed. In addition, surgery is generally reserved for patients who are seriously, and sometimes morbidly, overweight.

Most of the major surgical procedures (e.g., removal or blocking off of a portion of the stomach) currently in use have some immediate and/or delayed risks. Thus, surgery is usually considered as a solution when all less invasive procedures fail. Furthermore, even surgical treatment fails in some cases, thereby requiring the surgeon to restore the original anatomical situation.

Recently, implantable gastric stimulation systems have been developed to provide a significantly less invasive surgical approach for the treatment of obesity. In the treatment of obesity, the implantable gastric stimulation systems electrically stimulate or pace the stomach or intestinal tract with electrodes implanted in the abdomen tissue. The electrical stimulator can be programmed to induce in the stomach a motor in-coordination in order to slow down or even prevent stomach emptying.

Jenkins, et al., U.S. Published Application No. 2005/0080462 (“Jenkins, et al.”), filed on Sep. 30, 2004, the teachings of which are hereby incorporated herein in their entirety, describes methods for screening individuals at risk for a medical disorder (such as morbid obesity, gastrointestinal problems), or gastroesophageal problems to determine which individuals are likely to achieve a favorable outcome from a particular therapy, such as gastric stimulation. Jenkins et al. describe various methods of such screening involving methods of collecting data from the individual. In the methods described, the patient must complete one or more psychometric instruments such as a RAND Short Form 36 (SF-36); a Three-Factor Eating Questionnaire to measure dietary restraint, disinhibition and hunger; a Weight Locus of Control (WLOC) questionnaire, or the like, or such data is collected via a face-to-face interview. Other information regarding the individual, such as weight, height, age, sex is typically collected by the patient's health care provider.

These collection methods are typically performed during an office visit or consultation where the individual meets with a physician or other health care provider to discuss his or her weight loss goals and objectives. Simplified methods and systems for data collection are desired.

### BRIEF SUMMARY OF THE INVENTION

An internet- or equivalent-based system and method is disclosed which connects a remote patient who is a potential candidate for a particular treatment for weight loss to a network database for data review and evaluation to provide an assessment of whether the candidate is likely to achieve a favorable outcome from a given type of weight loss therapy. The system and method includes: 1) providing a web-site having a user interface wherein the user interface includes a secure sign-in input to access a database network site, 2) receiving at the web-site inputs associated with a specific individual, 3) confirming the identity of the individual and 4) enabling the individual to access a questionnaire. The system and method also includes in one embodiment a web-site having a user interface including a secure sign-in input for an individual's health care provider to access the database network site to input information concerning the individual and to obtain an access code for the individual to use to obtain access to the network.

A method is described of performing an automated assessment of an individual as a candidate for a particular weight loss therapy comprising the steps of: 1) having a health care provider to which the candidate has consulted regarding weight loss therapy alternatives submit information regarding the candidate's health to a database network site; 2) having the health care provider provide to the candidate a unique log-in password to allow the candidate to access the database network; 3) displaying a plurality of questions via the website to the candidate during a phase of the assessment; 4) sending to the database network site the candidate's responses to the plurality of questions; and 5) predicting a weight loss outcome for the candidate for the therapy using the information provided by the candidate and the health care provider gathered at the database network site. In one embodiment, the information provided by the candidate and health care provider relates to a pre-selected variable related to the candidate, and the predicted weight loss outcome is determined from the obtained information using an aggregated weight loss predictor developed from 1) observed similar types of information and corresponding weight loss information obtained from an actual population of patients who previously received a similar therapy to that proposed for the candidate, or 2) information generated from a simulated population by resampling the observed actual population information to produce pseudo-replicates.

The weight loss therapy may be applied through the use of an electrical stimulation system, a pharmaceutical substance or a medicine, a non-surgical behavioral modification, a gastric bypass type surgery, or a banding type device. In one embodiment, the electrical stimulation system is an implantable pulse generator. In another embodiment, the pharmaceutical substance or medicine is delivered through an implantable drug delivery system.

### BRIEF DESCRIPTION OF THE DRAWINGS

FIG. 1 is a flow chart of a preferred embodiment of the method of the present invention.

FIG. 2 is a flow chart of the steps a health care provider will follow in a method of the present invention.

FIGS. 3A-3H depict pages that may be displayed on a health care provider's computer while performing the method of the invention as described in FIG. 2.

FIG. 4 is a flow chart of the steps a candidate for a particular weight loss therapy will follow in a method of the present invention.

FIGS. 5A-5E depict pages that may be displayed on a candidate's computer while performing the method of the invention as described in FIG. 4.

FIG. 6 depicts a system for implementing a method of the invention.

FIG. 7 is a flow chart of the steps a system administrator for a system of the present invention will follow in implementing a method of the present invention.

### DETAILED DESCRIPTION OF THE INVENTION

A method and system for screening individuals to enable a physician or health care provider to predict whether the individual is likely to have a favorable outcome with a particular weight loss treatment is described by Jenkins, et al. The present invention describes a system and method that allow a patient's health care provider and the patient to remotely input information into the individual's or health care provider's computer system, which system is operably connected to a database network site.

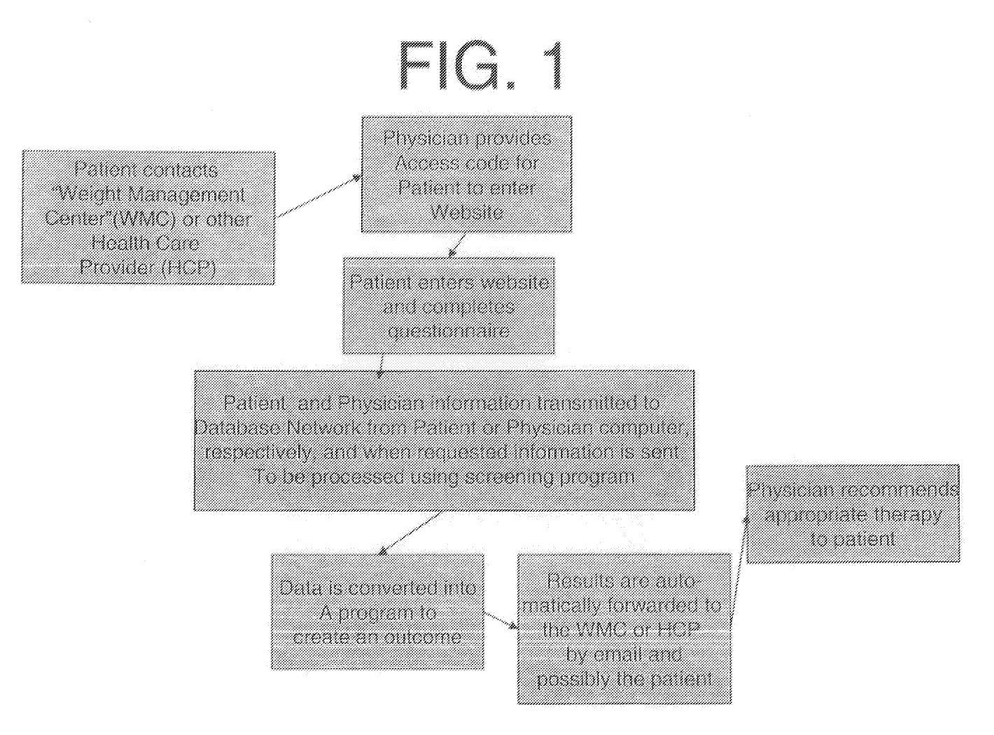

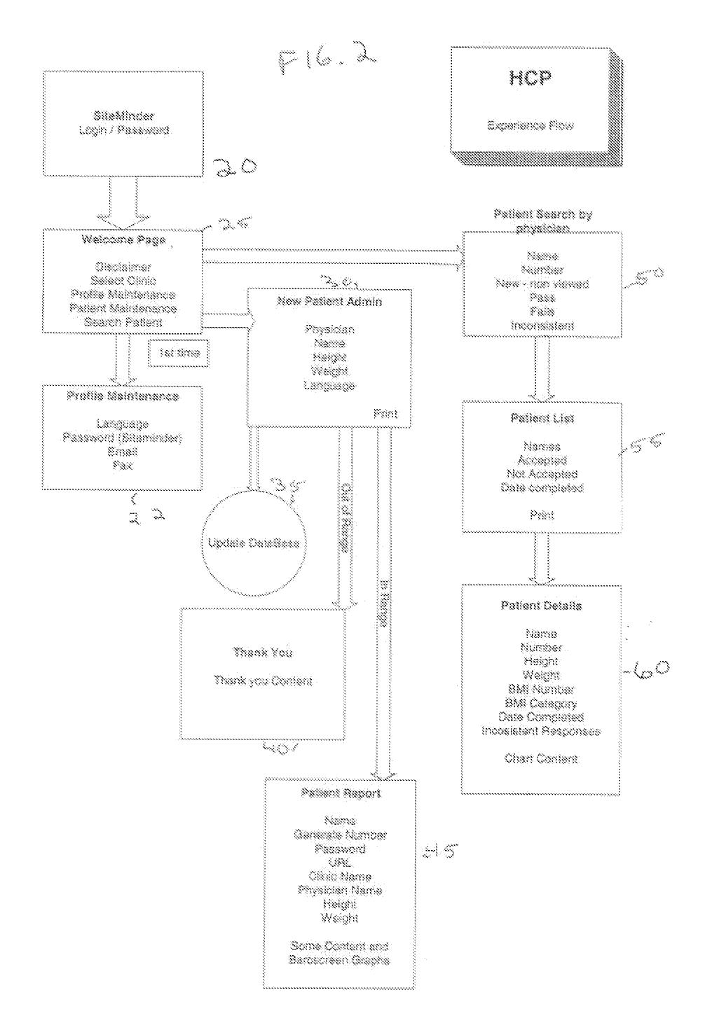

One embodiment of the method of the invention is depicted in the flow chart in FIG. 1. A patient desiring to lose weight visits a health care provider (a physician or its staff, nurse practitioner or clinician or the like) at a clinic or weight management center 10. During such visit the health care provider gathers identifying demographic and general health information about the patient as well as obtaining information regarding indices of risk factors associated with weight, such as indices of hip/waist ratio, BMI (Body Mass Index) or the like. If the patient and health care provider agree after the examination that the patient may be a potential candidate for one or more weight loss therapies or expected outcome for which a screening tool may be used to predict the patient's likelihood of success or expected outcome with such therapy then the health care provider (or someone on his or her behalf) will explain the screening process to the patient.

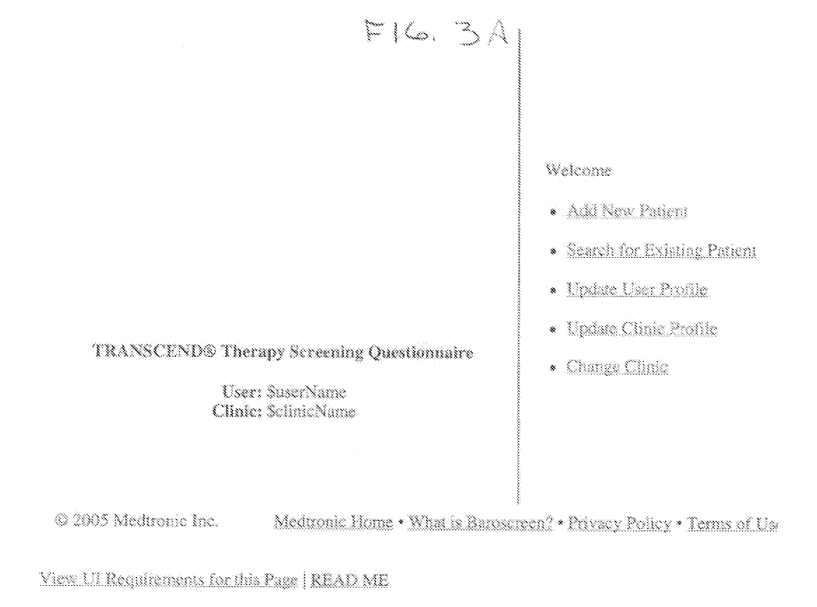

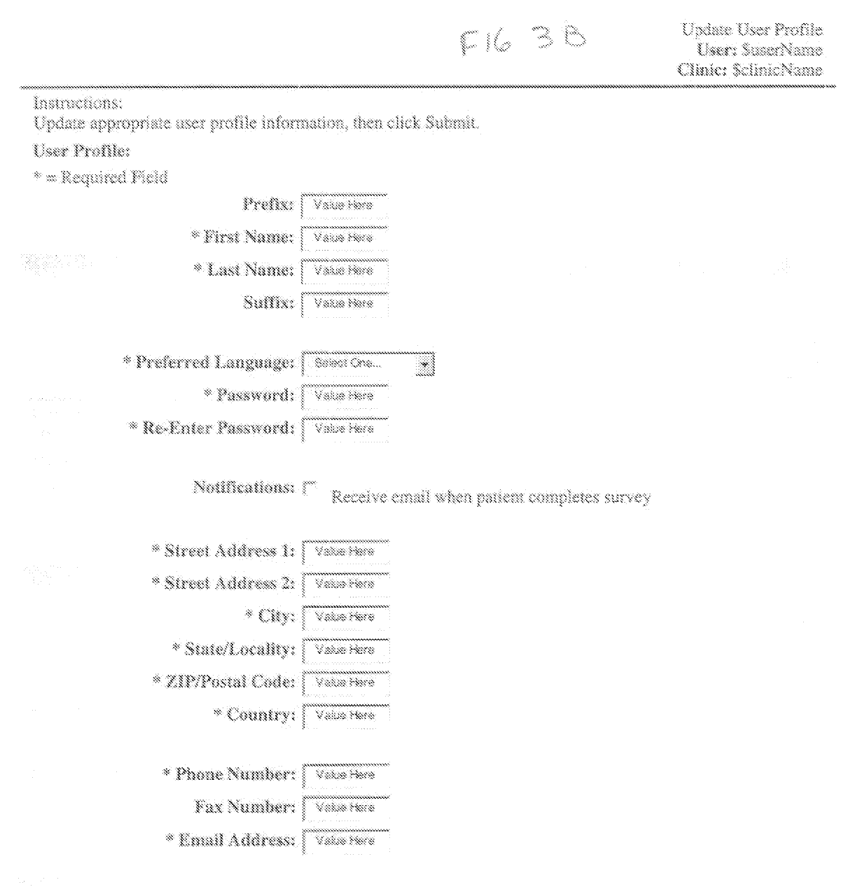

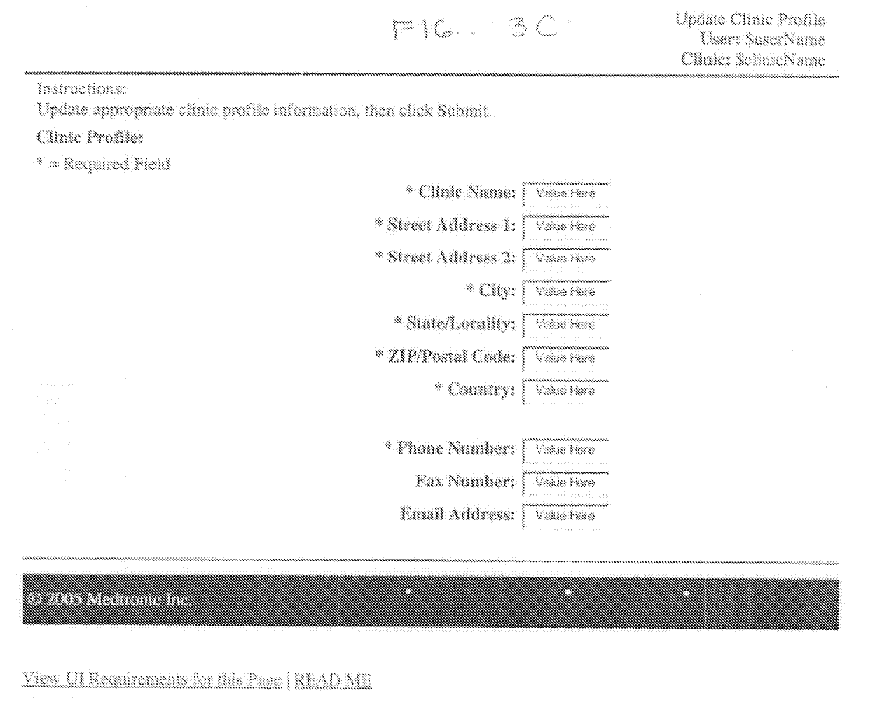

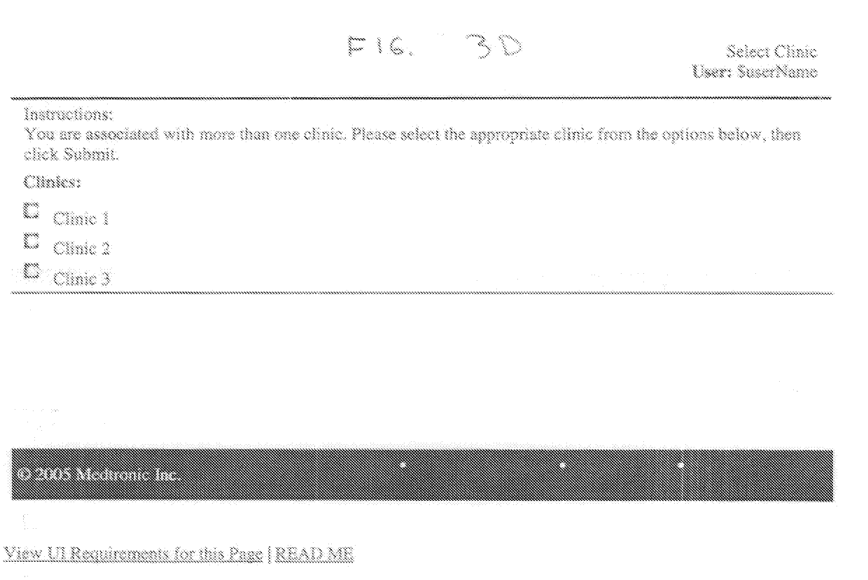

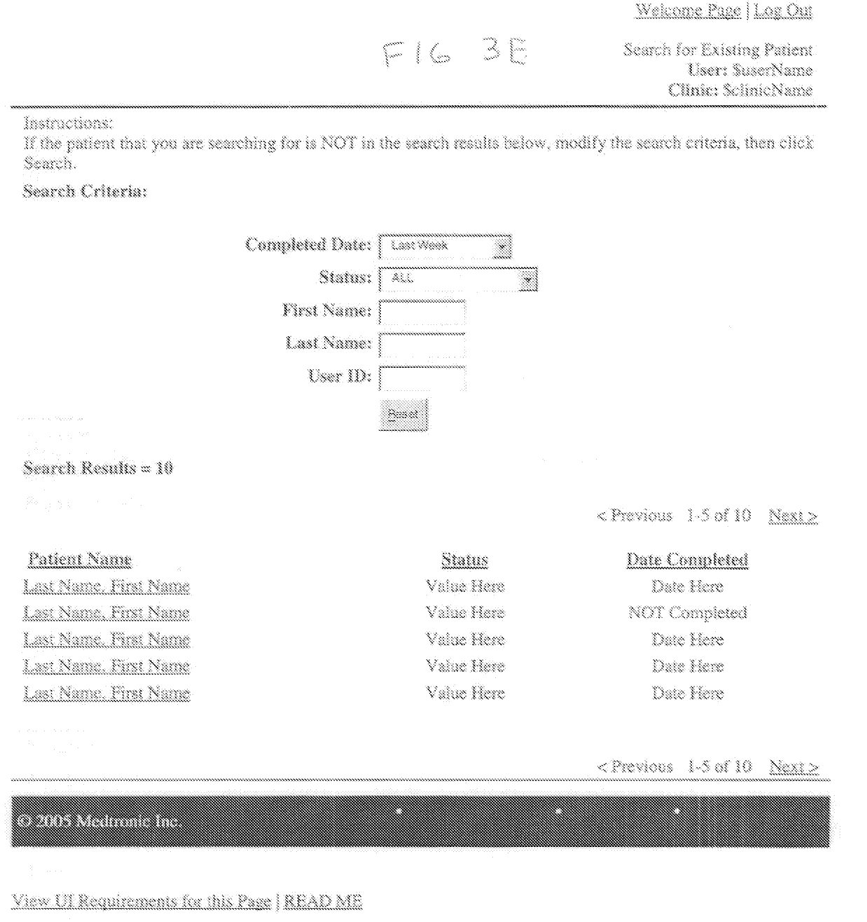

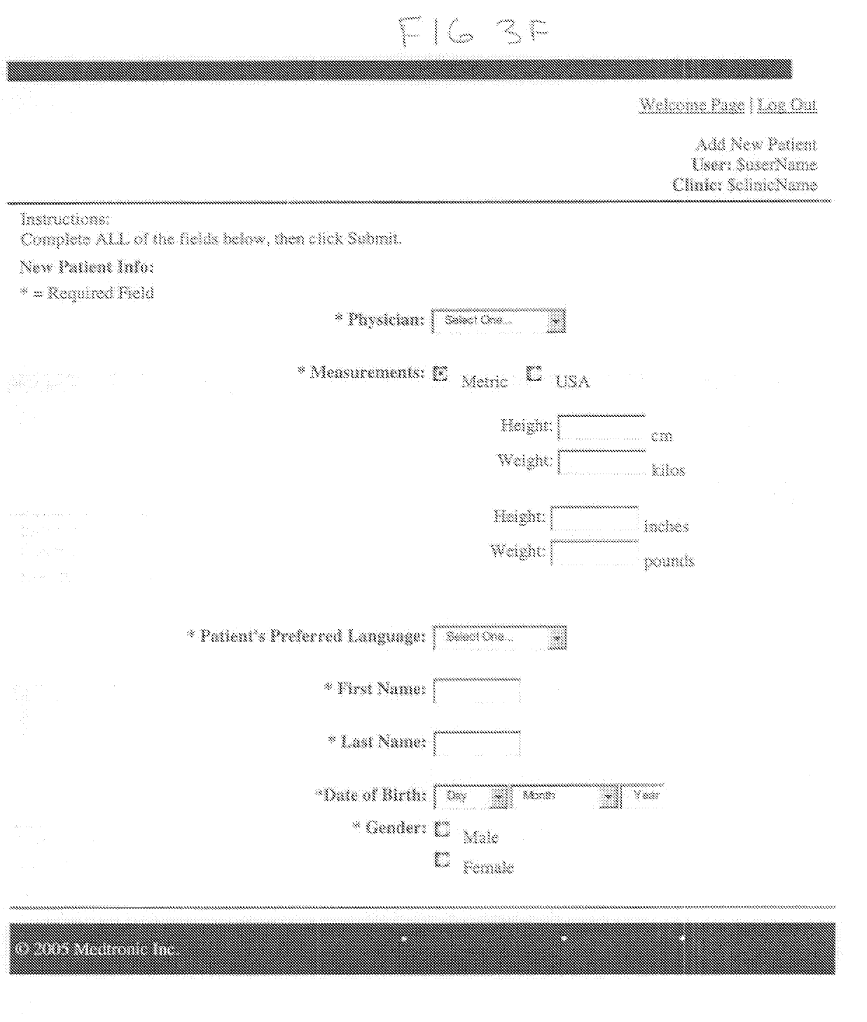

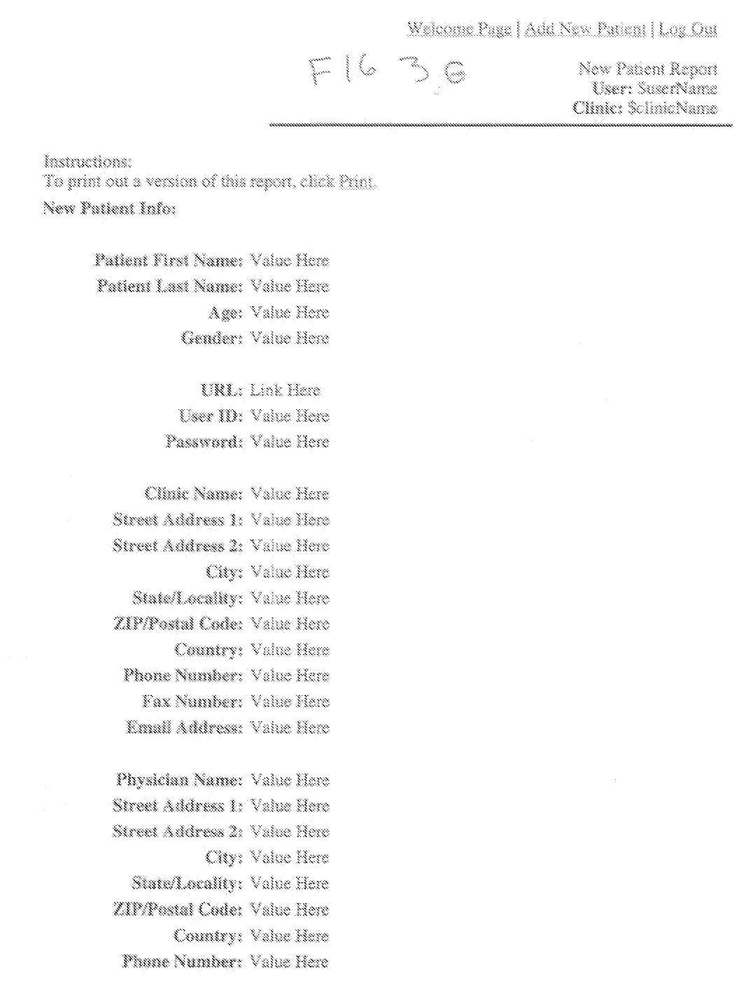

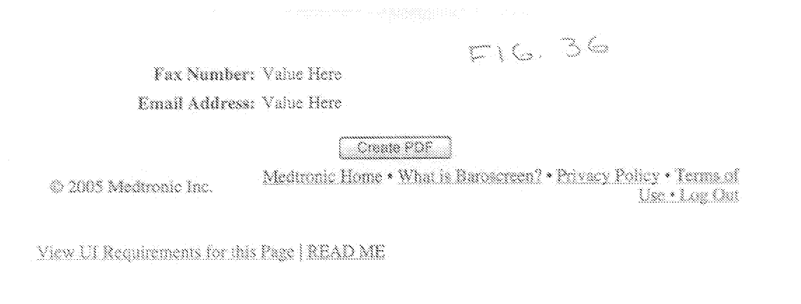

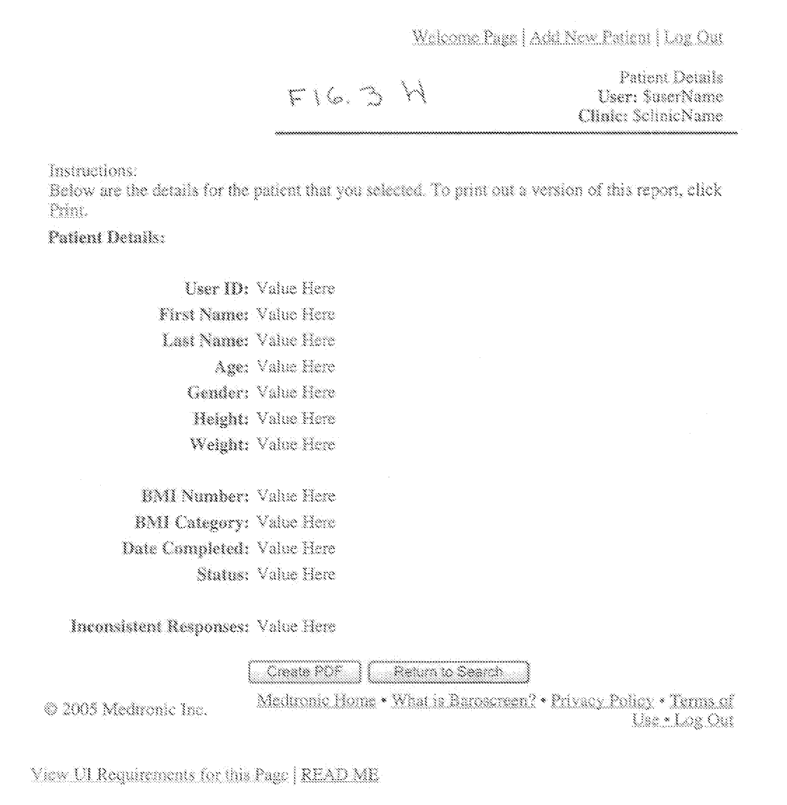

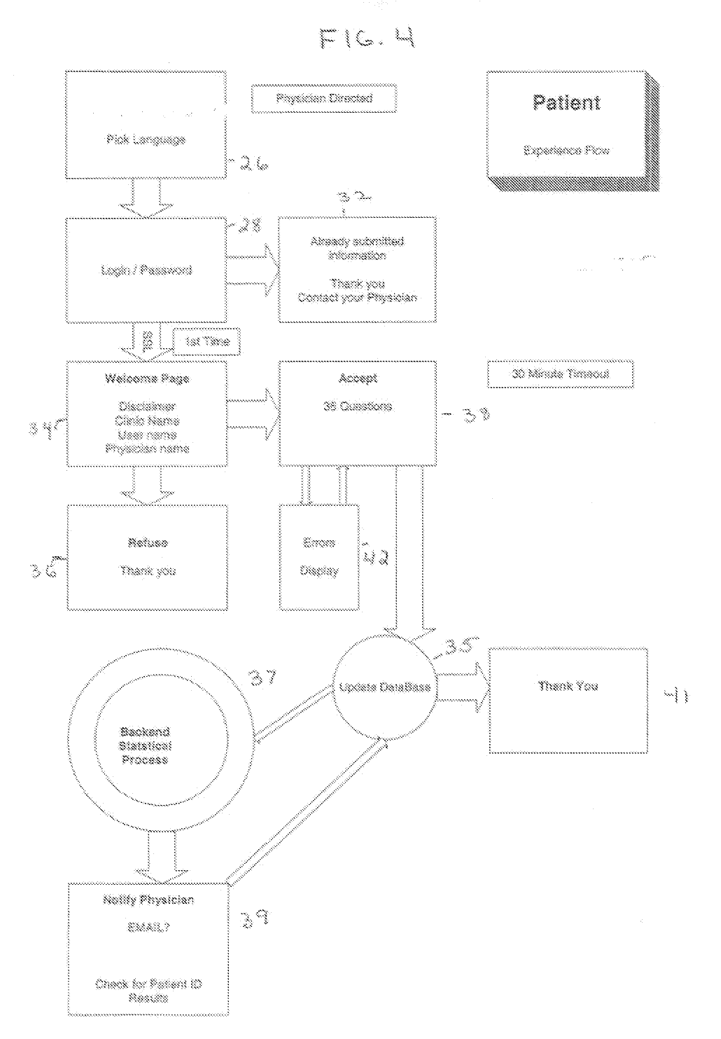

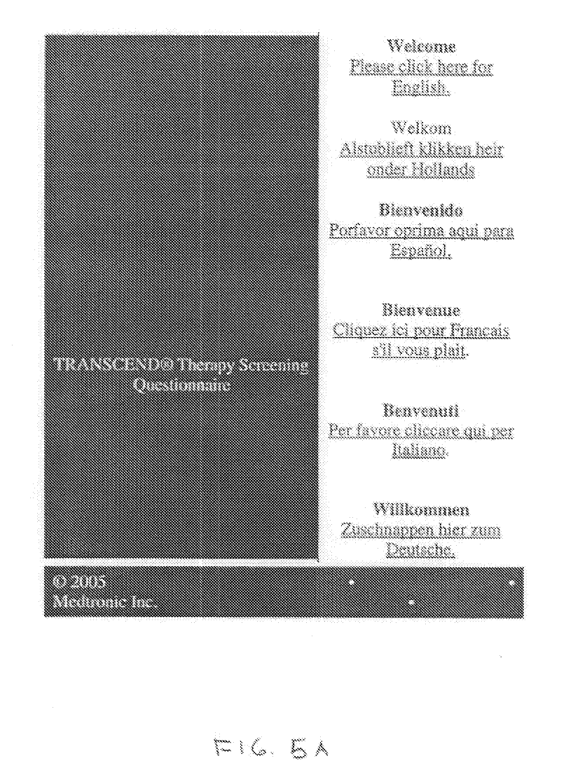

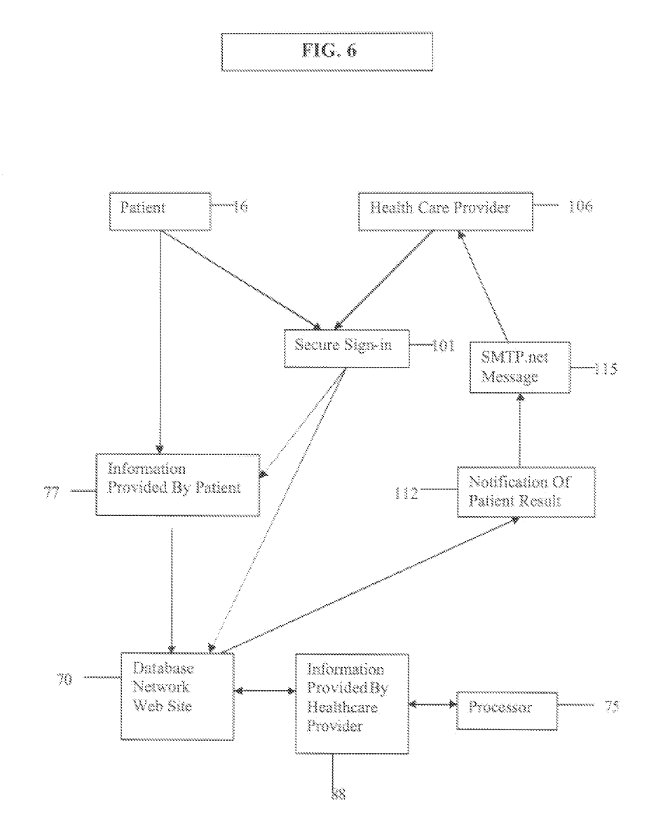

The health care provider then accesses a web-based or equivalent site such as the one shown in FIG. 6 configured to allow access by the health care provider and patient and others using one or more secure sign-in protocols. Once a health care provider has been registered as being among those granted access to the disclosed system, the health care provider can then enter information into the system using one method of the invention depicted in FIG. 2, wherein on-line input screens such as those shown in FIGS. 3A-3H are generated and displayed on the health care provider's personal computer. As shown in FIG. 2, the health care provider enters his or her user name and password at 20. A welcome page 25 is displayed such as that shown in FIG. 3A, which includes links to various other websites such as the “Privacy Policy” and a copy of the “Terms of Use” for the system. In one embodiment of the invention, the first time a health care provider accesses the system, he or she creates a profile 22 that includes the choice of language in which the information will be inputted, the ability to change the password from that which was originally provided, and entry of contact information for the health care provider, such as email address and fax number. FIG. 3B shows a screen that may be used to initially create a health care provider profile as well as to update information during subsequent sessions. FIGS. 3C and 3D may be used if the health care provider is associated with one or more clinics, as the user profile for the health care provider practicing at one clinic location may be different than the user profile for the same health care provider practicing at another clinic location. For example, at one location the health care provider may prefer to use Spanish as the language choice if his or her staff primarily speaks Spanish but prefer English at another location if the staff at the clinic primarily uses English. As shown in FIGS. 2 and 3A, the health care provider may choose to add a new patient to the system or search 50 for information on an existing patient. FIG. 3E shows an example of search criteria that may be used for a search.

FIG. 3F shows a web page that may be used to assist the health care provider to input information about a new patient. As shown in FIG. 2, a patient list 55 may be displayed with patient details 60.

After the health care provider has accessed the website and inputted new patient information as shown at 30 in FIG. 2, the information is transmitted to the database network site 35 for storage and processing. In one embodiment of the invention, the information is transmitted to the database network site and an administrator generates the user name and password for the health care provider to give the patient access to the system. This aspect of the invention allows the system and website to be accessed only by patients under the care of a health care provider and may allow the patient to request that certain information he or she inputs not be seen by the health care provider. If the patient information meets acceptance criteria stored on the system, a password is generated and a patient report 45, with information such as that shown in FIG. 3G, is created and transmitted to the health care provider to be printed and given to the patient. If the information provided by the health care provider is incomplete or suggests that the particular patient does not meet the criteria established for the particular weight loss therapy for which the patient would be evaluated, or if the health care provider is out of range, a message 40 is sent to the health care provider. After the patient submits his or her responses to the questionnaire as described below and the information from the health care provider and patient has been processed and an assessment made as to the candidate's likelihood of success or expected outcome with the proposed weight loss therapy, the health care provider is notified that the assessment report has been sent for that patient. The health care provider may then access the system and obtain a report in the form of the report shown in FIG. 3H showing the patient details.

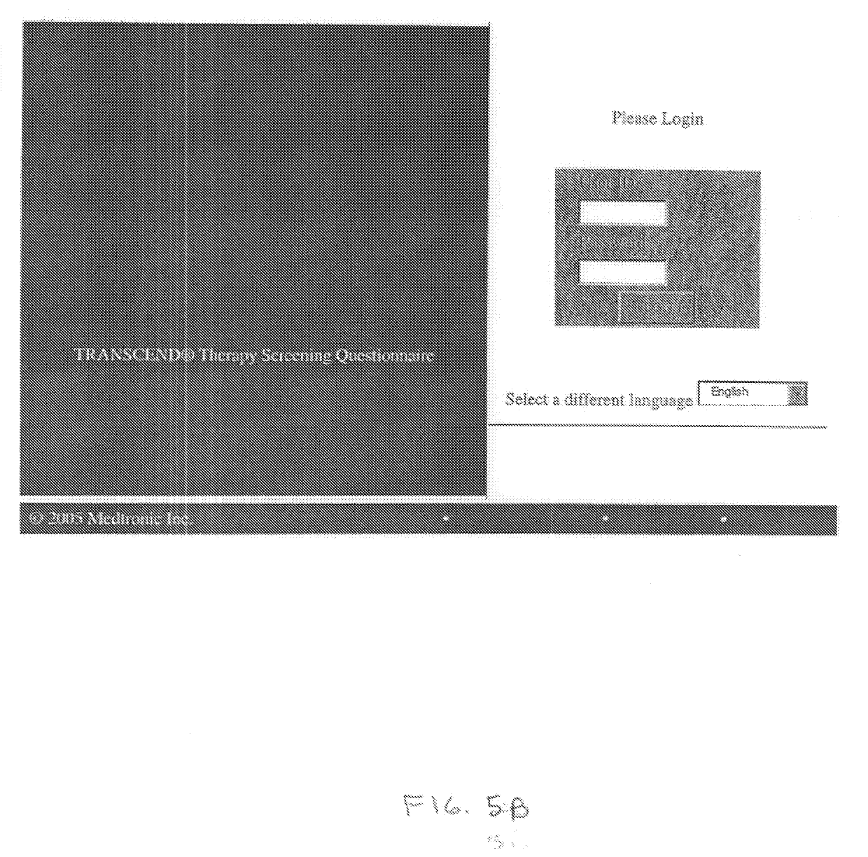

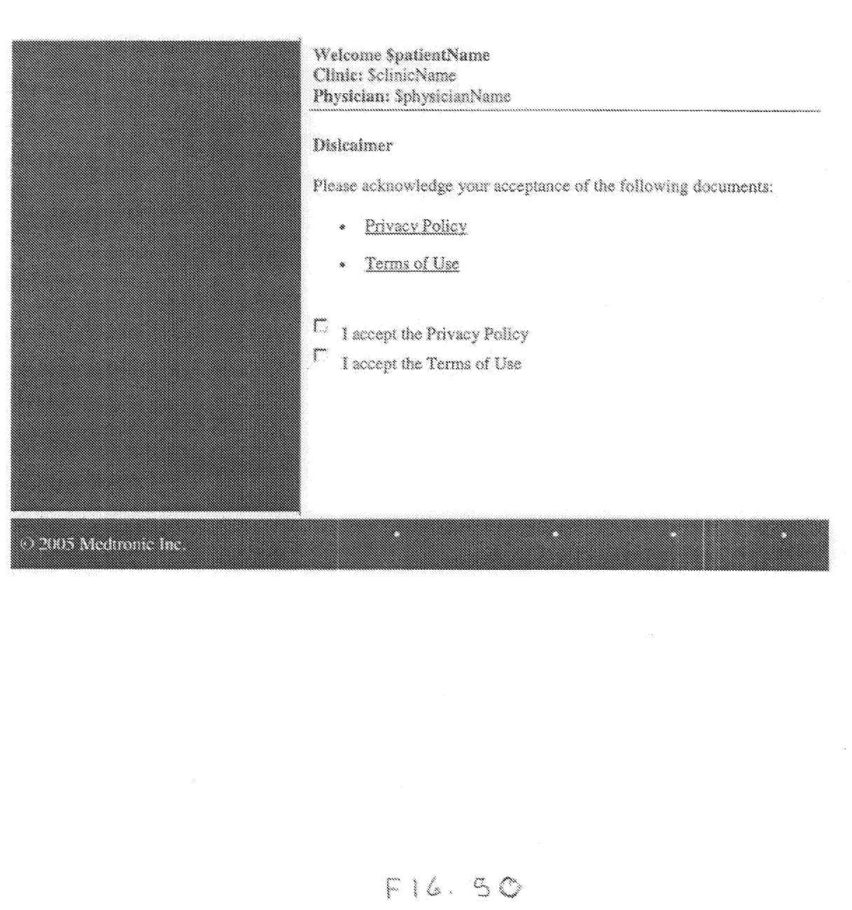

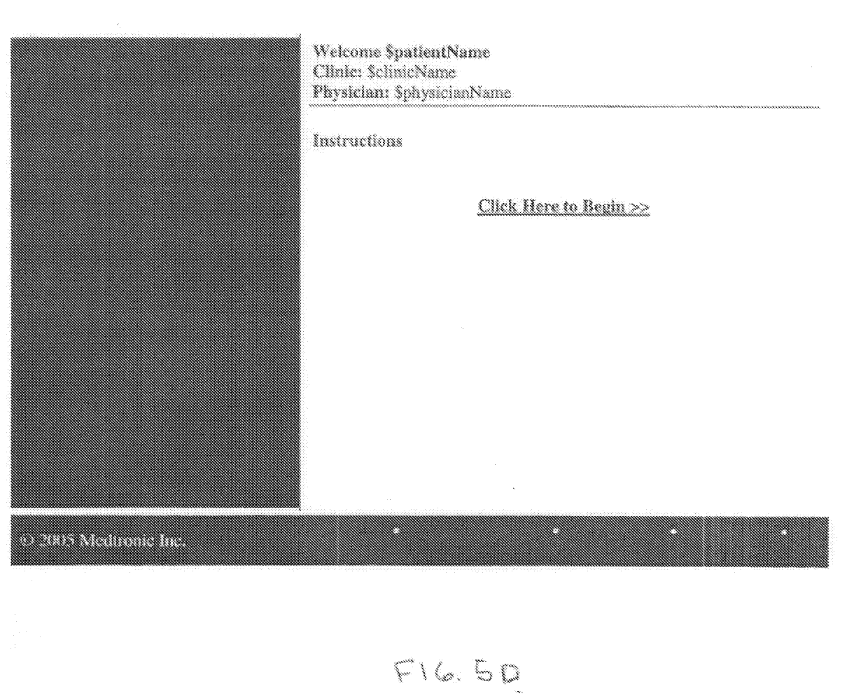

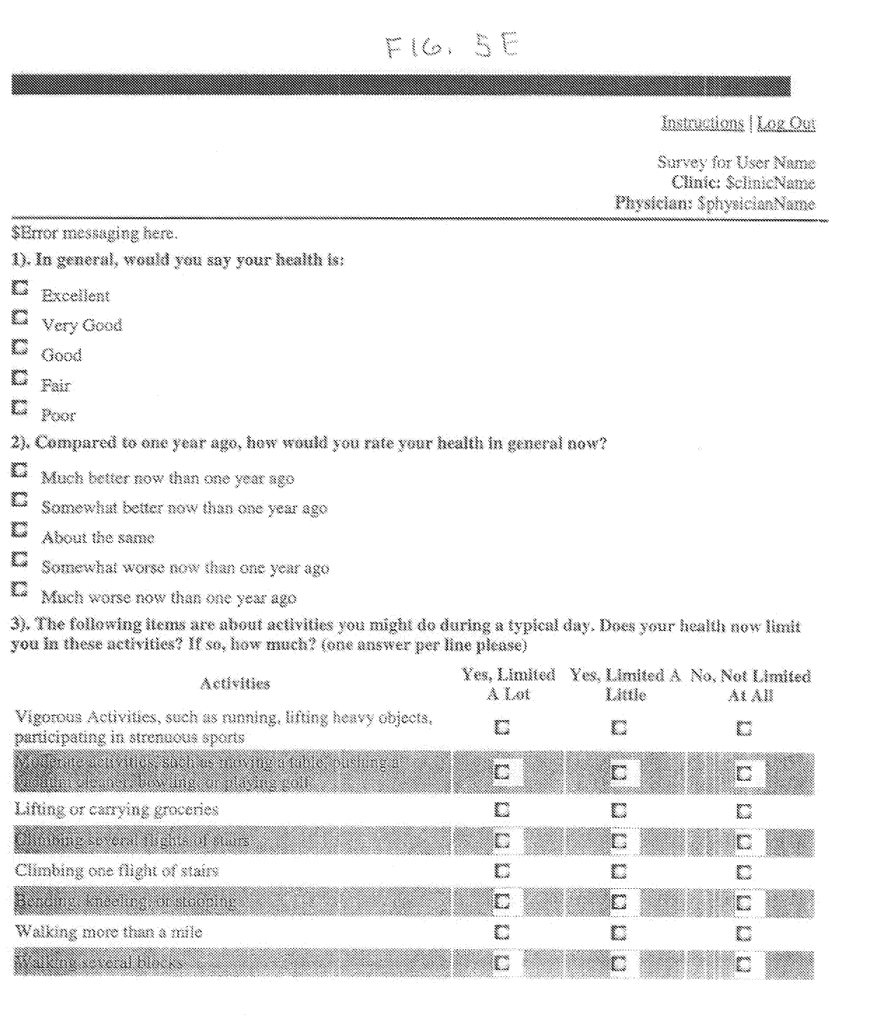

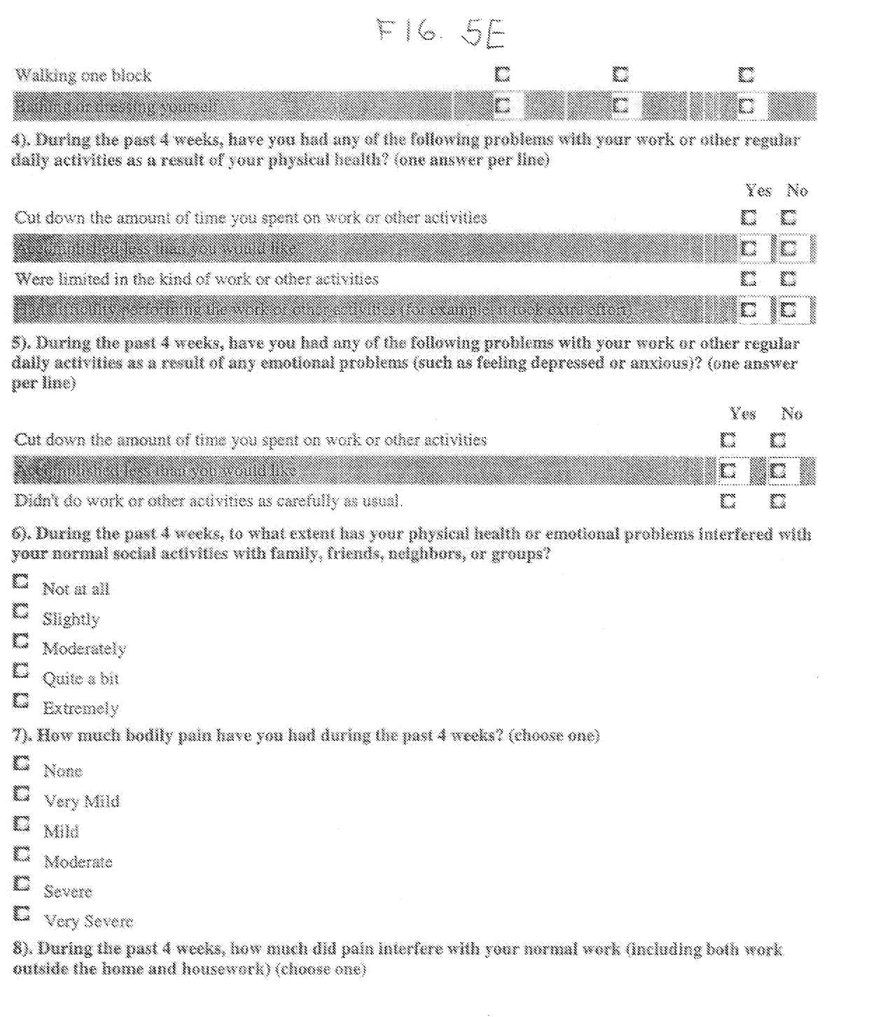

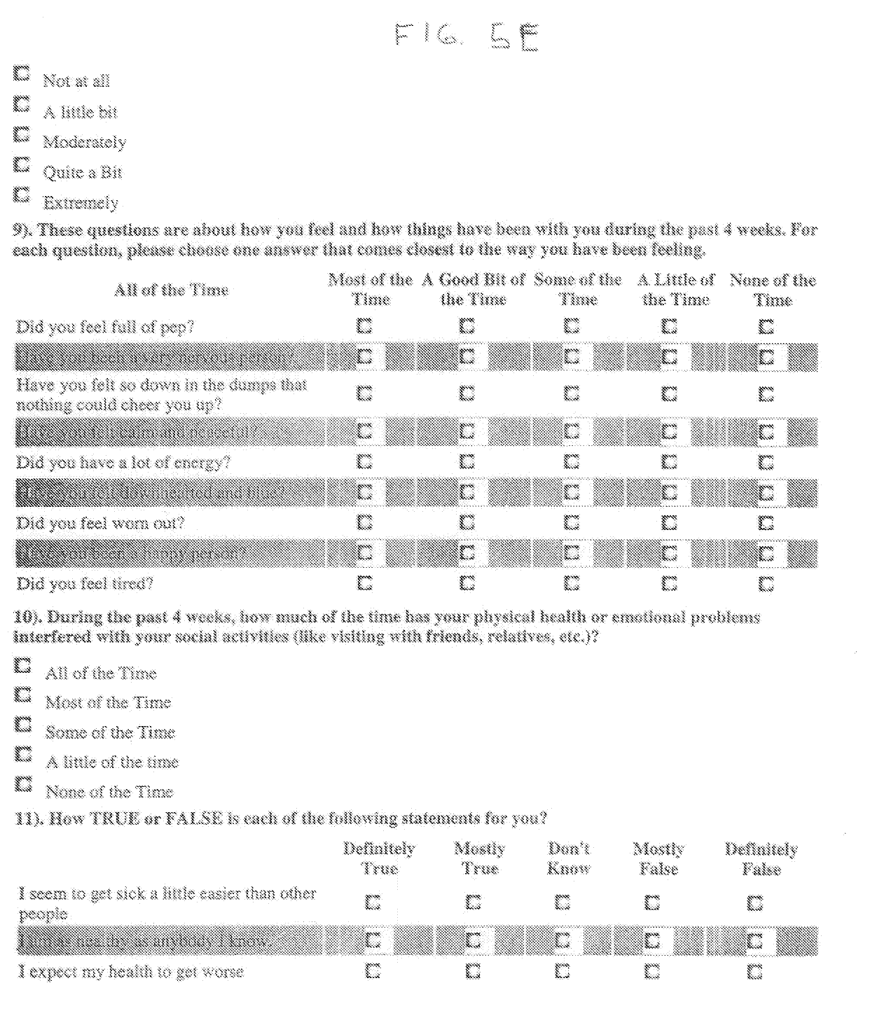

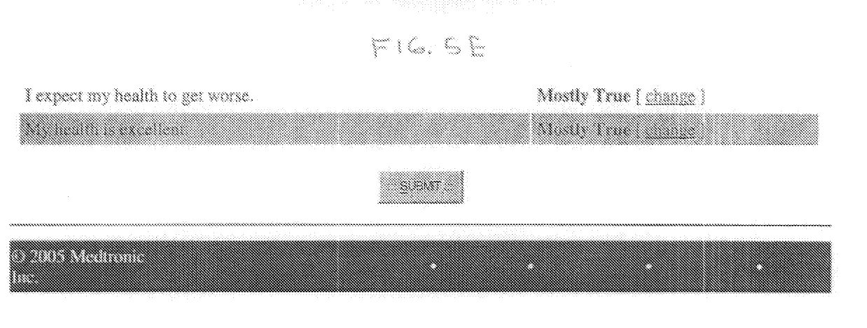

Once the health care provider has provided the patient with the unique ID/password that will allow the patient to access the system, the patient can choose to access the system remotely at his or her convenience in a comfortable environment from his or her own personal computer. Using one method of the invention depicted in FIG. 4 wherein on-line input screens such as those shown in FIGS. 5A-5E are generated and displayed on the patient's personal computer, the patient can input information and respond to a plurality of questions displayed. As shown in FIG. 4, the patient accesses the website as directed by his or her physician. In one embodiment, a webpage 26 is displayed, which may resemble the page shown in FIG. 5A that allows the patient to choose the language in which he or she wants to proceed. The patient must then enter his or her unique user name and password 28 obtained from the health care provider in order to access the system. In FIG. 5B a log-in page useful with the method of the invention is shown. Once the patient has entered an appropriate log-in, in one embodiment, a welcome page 34, with information such as that shown in FIG. 5C, may be displayed, which in the embodiment of the invention illustrated in the figures includes a link to terms of use, privacy policy and other disclaimers the site administrator has determined to be necessary. If the patient accepts or acknowledges his/her agreement to the terms of the site, the patient is connected to the system and a questionnaire 38 that is useful with a screening tool for determining whether a particular weight loss therapy will likely be successful for the patient is displayed. If the patient refuses a log-off message 36 is generated and the patient is logged off the system. In the embodiment of the invention described in FIGS. 4 and 5A-5E, once the patient accepts the terms of the site an instruction screen such as that shown in FIG. 5D is displayed and a questionnaire with questions such as those shown in FIG. 5E is displayed. Once the patient completes the questionnaire the information submitted is transmitted to the network database 35 where it is either processed or forwarded to another site such as that shown in FIG. 4 as the Backend Statistical Process 37 for processing. A log-off message 41 is sent to the patient letting him or her know that the session is complete. The result, which is an assessment as to the expected outcome of the proposed therapy, is obtained using an appropriate screening tool and forwarded directly to the health care provider 39; and, optionally, to the patient by email or other type of communication means; or a notification that the result is ready is sent to the health care provider. In a preferred embodiment, a notification that the result is ready is sent to the health care provider who contacts the patient and sets up a meeting with the patient in order to discuss the result in person.

In one embodiment, the patient can only access the website and complete the entire questionnaire one time even though the patient can access the website multiple times while completing the questionnaire. Once submitted, however, the patient cannot resubmit the questionnaire in connection with the evaluation of that patient as a potential candidate for a particular weight loss treatment. If the patient attempts to re-access the site, a message 32 will be displayed informing the patient to contact his or her health care provider. In the embodiment of the invention illustrated in the figures, the questionnaire, such as the one shown in FIG. 5E, is adapted to be used in the screening tool described in detail in Jenkins, et al., wherein the weight loss therapy for which the patient is being screened is an implantable gastric stimulator.

The questionnaire shown in FIG. 5E is adapted to obtain information from the patient concerning his or her state of mind and beliefs regarding diet, exercise, and the patient's overall perceptions of his or her health. In one embodiment of the invention, the health care provider is not provided with a copy of the patient's responses to the questionnaire, but only with the result of the processing of those responses. For some patients, the knowledge that the health care provider will not have access to his or her responses may result in more accurate responses.

FIG. 6 depicts a web-based or equivalent database network site 70 as a platform which is accessible via secure sign-in 101 by the health care provider 106 from a remote user interface. A variety of interactions are enabled by this relationship, including the use of web-based site 70 as a destination for secure access to provide and receive information pertinent to a particular candidate for a weight loss therapy, including information 77 submitted by the patient 16 via a secure log-in using a unique ID/password provided to the patient by the health care provider. In one embodiment, the patient's unique ID/password is provided by a site administrator, which is one or more individuals chosen to maintain the database network site and allow access to the database network site and associated screening tools only to health care providers and/or patients of health care providers that have agreed to pay a fee to use the database network site and associated screening tools. In one embodiment, information from the patient and health care provider 88 may be transmitted to a processor 75 where the information may be processed using a screening tool such as that described in Jenkins et al., to determine whether the patient is a candidate for a particular weight loss therapy, and that result is transmitted back to the network database site 70. In one embodiment, the web-based site 70 may be configured to provide an automatic notification service signal 112 to a display or other data receiving device of the health care provider when a result has been determined. In one example, the notification may be pushed via a SMTP.net message, shown for example as signal format 115, to the computer or other display of the health care provider 106. These displays, and others contemplated herein, may also include an automatic pushed signal via electronic mail, pager, cellular phone, WAP cellular phone, telephone call, facsimile, mobile wireless device, stylus tablet, or others. Web-based communication systems allowing the flow of data from a medical device implanted in a patient to a database network site and then to a health care provider are known as, for example, the systems and methods described in U.S. Published Application No. 2005/0021370 to Riff, et al., the teachings of which are incorporated herein in their entirety.

A screening tool useful with the method of the invention is that described in Jenkins, et al. and includes in one embodiment, a device having a microprocessor 75 that contains Classification and Regression Trees software developed and tested with historical patient data gleaned from a psychometric instrument (such as questionnaire shown in FIG. 5E), anthropometric data, the associated weight loss outcomes for those patients upon undergoing implantable gastric stimulation treatment for obesity, and biomarker data (which is optional in this illustration). The terminology “implantable gastric stimulation” is occasionally abbreviated herein as “GS.” Anthropometric data may include, e.g., weight, height, age, sex, and body mass index (BMI) information. Biomarker information may include, e.g., hormone information, peptide information (e.g., ghrelin peptide information), genomics information, and body scan information (e.g., a positron emission tomography brain scan), or any combination thereof. The data supplied by the candidates for implantable gastric stimulation therapy is processed by the predictive model to determine the associated predicted weight loss via implantable gastric stimulation therapy for a given candidate. If the predicted weight loss meets an arbitrary minimum percentage correlated with a reasonably significant and meaningful outcome to implantable gastric stimulation therapy by health professionals in this field, then the candidate is “approved” for the implantable gastric stimulation therapy. On the other hand, a candidate who does not meet the criteria can consult with his or her health care practitioner about alternative therapies at an early juncture while foregoing the time and cost that otherwise may have been devoted to implantable gastric stimulation therapy with little prospect of a favorable outcome. It will be appreciated that other algorithms might be used in lieu of a decision tree-based analysis, such as a neural network analysis.

The acronym “CART” stands for Classification and Regression Trees. Many other tree-based algorithms can be grouped under the same heading. CART is a flexible, nonparametric algorithm for building either classification or regression trees that has proven to be a useful predictor in many different contexts. Alternatively, Quinlan's C4.5 algorithm (see, e.g., Quinlan, J. R., Programs for Machine Learning, The Morgan Kaufman Series in Machine Learning, Morgan Kaufman Publ., San Mateo, Calif. (1993)), or Friedman's Multivariate Adaptive Regression Splines (MARS) or Multivariate Adaptive Regression Trees (MART) algorithms (see, e.g., Hastie, T., Tibsharani, R., and Friedman, J., The Elements of Statistical Learning: Data Mining, Inference and Prediction, Springer Series in Statistics, Springer Publication, New York, N.Y. (2001) (“Hastie et al.”) could be adapted for analysis of the implantable gastric stimulation trial data. Other machine learning methods, not based on classification or regression trees, could also be employed in place of CART. Examples of such methods include linear discriminant analysis, nearest neighbor methods, artificial neural networks and support vector machines (see, e.g., Hastie et al.).

Decision-tree based methods are only a modest subset of the data mining tools available for predictive modeling. Leading alternatives include k-Nearest Neighbor methods (see, e.g., Duda, R., et al., Pattern Classification and Scene Analysis, New York, John Wiley & Sons, 1973), and Neural Network methods (see, e.g., Rumelhart, D., et al., “Learning internal representations by error propagation,” in Parallel Distributed Processing Exploration of the Microstructure of Cognition, Cambridge, Mass.: MIT Press 1986). While it is unlikely to appear so to those unfamiliar with data mining algorithms, tree-based methods are far less of a “black box” than the alternatives that provide superior prediction. The algorithm used to construct CART regression trees is relatively simple to describe in plain English, with minimal reference to mathematics and statistics. Interpretability is further aided by the fact that the predictive model is expressed in the form of a decision tree, a device commonly used in both managerial and medical decision making.

A recent innovation in data mining known as “boosting” has been shown to dramatically reduce the generalization error associated with tree-based methods. Simulation studies by Breiman and others have found that using boosting in conjunction with tree-based predictors like CART yields mean test set prediction error that approaches the minimum possible (i.e., the level attainable using the true conditional expectation of the target given the predictors).

In one embodiment, the analysis of the information employs the variant of boosting developed by Breiman referred to as “adaptive resampling and combining,” or “arcing”. See, e.g., See Breiman, L., Arcing Classifiers, Annals of Statistics, 1998. 26:801-49. Boosting reduces the generalization error associated with CART trees by combining predictions from many trees, typically 250 or more, each estimated in a different perturbed version of the observed training sample. The perturbed data sets are a sequence of bootstrap training samples, generated by random draws with replacement from the observed sample.

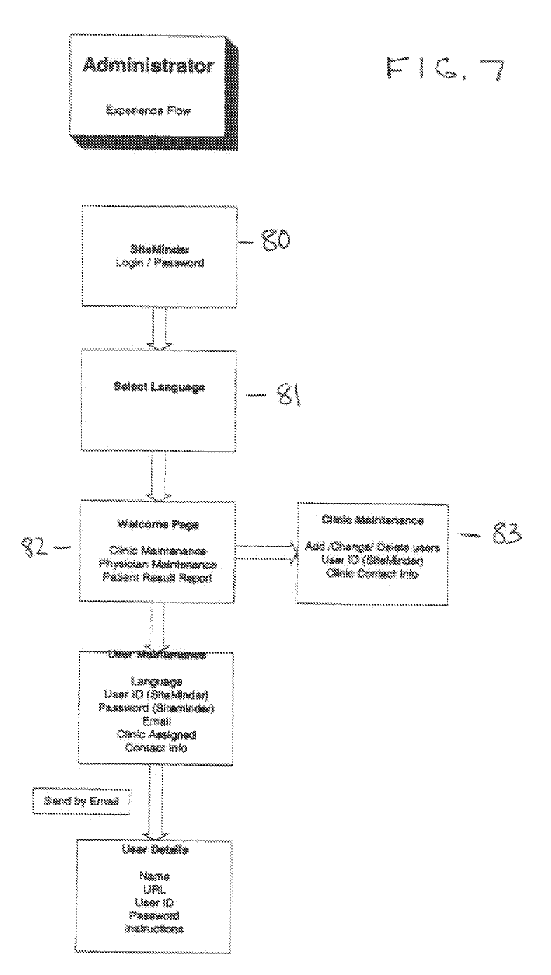

FIG. 7 shows a method of the invention where an administrator manages the database network and access to a screening tool for predicting the success of a particular weight loss therapy for a candidate. The administrator logs onto the site using a login name and a password 80. After the administrator logs in, he/she then selects a language in which to proceed, such as English, Spanish, or any other language 81. He/she is then taken to a welcome page 82 where the administrator may choose to perform a variety of tasks such as clinic maintenance, physician maintenance, or formatting patient result report.

During clinic maintenance 83, the administrator may add/change/delete information associated with a clinic or a health care facility, including but not limited to users, user IDs, and/or clinic contact info. During physician maintenance, the administrator may add/change/delete information associated with a health care provider, including but not limited to, user ID, password, email, clinic assigned, and/or contact info. During formatting the patient result report, based on specifications from a clinic, the administrator customizes the content and format for all reports that are to be sent to patients from that particular clinic.

It will be appreciated that the present invention can take many forms and embodiments.

The true essence and spirit of the invention are defined in the appended claims, and it is not intended that the embodiment of the invention presented herein should limit the scope thereof.

What is claimed is:

1. A method for performing an automated assessment of an individual as a candidate for a proposed weight loss therapy comprising the steps of:
a) having a health care provider to whom the candidate has consulted regarding a weight loss therapy provide the candidate with a unique log-in password to allow the candidate to access a website;
b) displaying a plurality of questions via the website to the candidate following the candidate's accessing the website;
c) sending to a database network site the candidate's responses to the plurality of questions; and
d) providing to the health care provider the assessment regarding a predicted weight loss outcome for the candidate for the proposed weight loss therapy using the information provided by the candidate, whereby the assessment is provided to the health care provider through a website accessible with a unique log-in password that allows the health care provider to access the website,.

2. The method of claim 1 further comprising the step of having the health care provider submit information regarding the candidate's physical and medical health to the database network site and wherein the step of predicting a weight loss outcome for the candidate for the weight loss therapy also includes using the information provided by the health care provider.

3. The method of claim 2 wherein the predicted weight loss outcome is determined from the obtained information using an aggregated weight loss predictor developed from a) observed similar types of information and corresponding weight loss information obtained from an actual population of patients who previously received a similar therapy to that proposed for the candidate, or b) information generated from a simulated population by resampling the observed actual population information to produce pseudo-replicates.

4. The method of claim 3 wherein predicting the weight loss outcome comprises processing the items of information using an aggregated classification or regression tree model formed using a committee or ensemble method combining multiple predictors trained in perturbed versions of the observed types of information and corresponding weight loss information obtained from the actual population of patients.

5. The method of claim 3 wherein predicting the weight loss outcome comprises processing the items of information using a predictive model developed using machine learning methods selected from the group consisting of alternative tree-based algorithms, discriminant analysis, nearest neighbor methods, artificial neural networks and support vector machines.

6. The method of claim 1 wherein the proposed weight loss therapy is applied through the use of an electrical stimulation system.

7. The method of claim 1 wherein the proposed weight loss therapy is a pharmaceutical or medicinal therapy.

8. The method of claim 1 wherein the proposed weight loss therapy is a non-surgical behavioral modification.

9. The method of claim 1 wherein the proposed weight loss therapy is a gastric bypass type surgery.

10. The method of claim 1 wherein the proposed weight loss therapy is application of a banding type device.

11. The method of claim 6, wherein the electrical stimulation system comprises an implantable pulse generator.

12. The method of claim 11, wherein the implantable pulse generator is an implantable gastric stimulator.

13. The method of claim 11, wherein the implantable pulse generator is an implantable neurostimulator.

14. The method of claim 7, wherein the pharmaceutical or medicinal therapy is delivered through an implantable drug delivery system.

15. A method for performing an automated assessment of an individual as a candidate for a proposed weight loss therapy comprising the steps of:
a) having a health care provider to which the candidate has consulted regarding a weight loss therapy provide the candidate with a unique log-in password to allow the candidate to access a website and submit information to the database network site regarding the candidate's physical and medical health;
b) displaying a plurality of questions via the website to the candidate following the candidate's accessing the website;
c) sending to a database network site the candidate's responses to the plurality of questions; and
d) providing to the health care provider the assessment regarding a predicted weight loss outcome for the candidate for the proposed weight loss therapy wherein the assessment was made using the information provided by the candidate and the health care provider, and whereby the assessment is provided to the health care provider through a website accessible by the health care provider with a unique log-in password that allows the health care provider to access the website.

16. The method of claim 15 wherein the predicted weight loss outcome is determined from the obtained information using an aggregated weight loss predictor developed from i) observed similar types of information and corresponding weight loss information obtained from an actual population of patients who previously received a similar therapy to that proposed for the candidate, or ii) information generated from a simulated population by resampling the observed actual population information to produce pseudo-replicates.

17. The method of claim 16 wherein predicting the weight loss outcome comprises processing the items of information using an aggregated classification or regression tree model formed using a committee or ensemble method combining multiple predictors trained in perturbed versions of the observed types of information and corresponding weight loss information obtained from the actual population of patients.

18. The method of claim 16 wherein predicting the weight loss outcome comprises processing the items of information using a predictive model developed using machine learning methods selected from the group consisting of alternative tree-based algorithms, discriminant analysis, nearest neighbor methods, artificial neural networks and support vector machines.

19. The method of claim 16, wherein the plurality of questions answered by the candidate comprises psychometric data.

20. The method of claim 19, wherein the plurality of questions includes questions asked in a RAND Short Form 36 (SF-36) health survey.

21. The method of claim 15, wherein the plurality of questions include questions to obtain items of information from the candidate selected from at least one of symptoms, demographics, tests of psychological well being, family history, eating habits, diet, exercise, and other attempted weight loss therapies.

22. The method of claim 15, wherein the information provided by the health care provider regarding the candidate's physical and medical health comprises anthropometric data.
